(19) United States
(12) Patent Application Publication
(10) Pub. No.: US 2016/0091526 A1
(43) Pub. Date: Mar. 31, 2016

(54) SENSOR

(71) Applicant: PANASONIC INTELLECTUAL PROPERTY MANAGEMENT CO., LTD., Osaka-shi, Osaka (JP)

(72) Inventors: KAZUO GODA, Osaka (JP); NOBUYUKI IBARA, Mie (JP); HITOSHI YOSHIDA, Osaka (JP); TAKUMI TAURA, Kyoto (JP); SHINICHI KISHIMOTO, Osaka (JP); HIDEKI UEDA, Fukui (JP); TAKESHI MORI, Osaka (JP)

(21) Appl. No.: 14/892,566

(22) PCT Filed: Jun. 10, 2014
(86) PCT No.: PCT/JP2014/003081

§ 371 Date: Nov. 19, 2015

(30) Foreign Application Priority Data
Jul. 19, 2013 (JP) 2013-150292

(51) Int. Cl. G01P 15/125; G01P 15/18

(52) U.S. Cl. CPC G01P 15/125; G01P 15/18

(57) ABSTRACT

A configuration including a first substrate including a first movable electrode; a second substrate connected to the first substrate and including a first fixed electrode that faces the first movable electrode; and a third substrate connected to the second substrate. The first substrate, the second substrate, and the third substrate are laminated in this order, and the second substrate and the third substrate are not bonded to each other in at least a part between the first fixed electrode and the third substrate.

### TECHNICAL FIELD

The present invention relates to a sensor such as an acceleration sensor and an angular velocity sensor used in electronic equipment.

### BACKGROUND ART

An electrostatic capacitance-type acceleration sensor detects acceleration based on a change of electrostatic capacitance between a weight (movable electrode) and a fixed electrode (see, for example, PTLs 1 to 4). An acceleration sensor for detecting acceleration in the three mutually-orthogonal axial directions of X, Y, and Z is also known.

### CITATION LIST

### Patent Literature

PTL 1: Japanese Patent Application Unexamined Publication No. 2006-250702
PTL 2: Japanese Patent Application Unexamined Publication No. H05-333056
PTL 3: Japanese Patent Application Unexamined Publication No. 2009-260272
PTL 4: Japanese Patent Application. Unexamined Publication No. 2012-232405

### SUMMARY OF THE INVENTION

However, when a sensor chip is adhesively bonded to a mounting substrate with die-bonding material, thermal hysteresis in offset temperature characteristics may occur due to an effect of the die-bonding material.

Thus, an object of the present invention is to achieve a sensor capable of suppressing occurrence of thermal hysteresis in offset temperature characteristics more stably.

The present invention has a configuration including a first substrate including a first movable electrode; a second substrate connected to the first substrate and including a first fixed electrode that faces the first movable electrode; and a third substrate connected to the second substrate. The first substrate, the second substrate, and the third substrate are laminated in this order, and the second substrate and the third substrate are not bonded to each other in at least a part between the first fixed electrode and the third substrate.

The present invention can provide a sensor such as an acceleration sensor and an angular velocity sensor capable of suppressing occurrence of thermal hysteresis in offset temperature characteristics more stably.

### BRIEF DESCRIPTION OF THE DRAWINGS

FIG. 1 is a perspective view showing an internal configuration example of a package that incorporates an acceleration sensor in accordance with an exemplary embodiment.

FIG. 2 is an exploded perspective view of the acceleration sensor in accordance with this exemplary embodiment.

FIG. 3A is a sectional view of an X detection portion of the acceleration sensor in accordance with this exemplary embodiment.

FIG. 3B is a sectional view of a Z detection portion of the acceleration sensor in accordance with this exemplary embodiment.

FIG. 4 is a sectional view of the X detection portion in a state in which acceleration in an X direction is not applied in the acceleration sensor in accordance with this exemplary embodiment.

FIG. 5 is a view for illustrating a principle of detecting the acceleration in the X direction in the acceleration sensor shown in FIG. 4.

FIG. 6 is a sectional view of the X detection portion in a state in which acceleration of 1 G is applied in the X direction in the acceleration sensor in accordance with this exemplary embodiment.

FIG. 7 is a view for illustrating a principle of detecting the acceleration in the X direction in the acceleration sensor shown in FIG. 6.

FIG. 8 is a sectional view of the Z detection portion in a state in which acceleration of 1 G is applied in the Z direction in the acceleration sensor in accordance with this exemplary embodiment.

FIG. 9 is a view for illustrating a principle of detecting the acceleration in the Z direction in the acceleration sensor shown in FIG. 8.

FIG. 10A is a photograph of an adhesive bonding surface of a sensor chip of the acceleration sensor in accordance with this exemplary embodiment.

FIG. 10B is a graph showing offset temperature characteristics of the acceleration sensor in accordance with this exemplary embodiment.

FIG. 11 is a sectional view of the acceleration sensor and the mounting substrate thereof in accordance with this exemplary embodiment.

FIG. 12A is a sectional view of an attachment preventing structure of the acceleration sensor in accordance with this exemplary embodiment.

FIG. 12B is a sectional view of another attachment preventing structure of the acceleration sensor in accordance with this exemplary embodiment.

FIG. 12C is a sectional view of still another attachment preventing structure of the acceleration sensor in accordance with this exemplary embodiment.

FIG. 12D is a sectional view of yet another attachment preventing structure of the acceleration sensor in accordance with this exemplary embodiment.

FIG. 13A is a sectional view of an attachment preventing structure of the mounting substrate of the acceleration sensor in accordance with this exemplary embodiment.

FIG. 13B is a sectional view of another attachment preventing structure of the mounting substrate of the acceleration sensor in accordance with this exemplary embodiment.

FIG. 13C is a sectional view of still another attachment preventing structure of the mounting substrate of the acceleration sensor in accordance with this exemplary embodiment.

FIG. 13D is a sectional view of yet another attachment preventing structure of the mounting substrate of the acceleration sensor in accordance with this exemplary embodiment.

### DESCRIPTION OF EMBODIMENTS

Hereinafter, exemplary embodiments of the present invention are described with reference to drawings. Note here that, hereinafter, common reference numerals are given to similar components, and descriptions thereof are not repeated. Furthermore, each drawing shows one example of preferable embodiments, and is not necessarily limited to the shape.

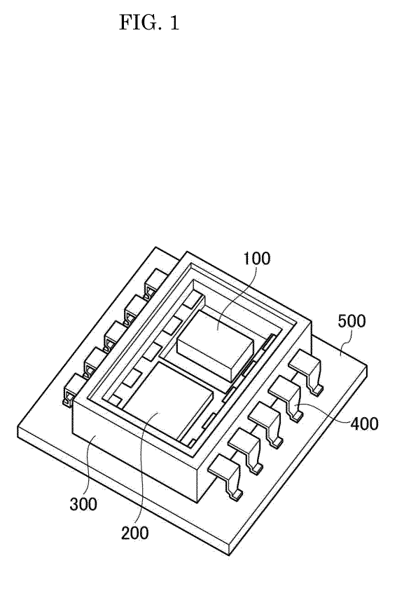

FIG. 1 is a perspective view showing an internal configuration example of package 300 in which a sensor is installed in accordance with this exemplary embodiment. This drawing shows a state in which a lid of package 300 mounted on substrate 500 is opened. As shown in this drawing, in package 300, for example, sensor chip 100 and ASIC (application specific integrated circuit) 200 for performing a variety of operations based on an output from sensor chip 100 are installed. Terminals 400 are pulled out from package 300 and are connected to substrate 500. This sensor is an electrostatic capacitance-type sensor for detecting acceleration, and is manufactured by MEMS technology. In order to detect acceleration in the three-axial directions of X, Y, and Z, weights (movable electrodes) for individual axes are formed and disposed inside sensor chip 100. Note here that the present invention is not limited to the electrostatic capacitance type sensor for detecting acceleration. The present invention can be applied to, for example, an electrostatic capacitance type sensor for detecting an angular velocity. Note here that the present invention is not limited to the sensor for detecting three-axis acceleration. For example, the present invention can be used for a sensor for detecting one- or two-axis acceleration.

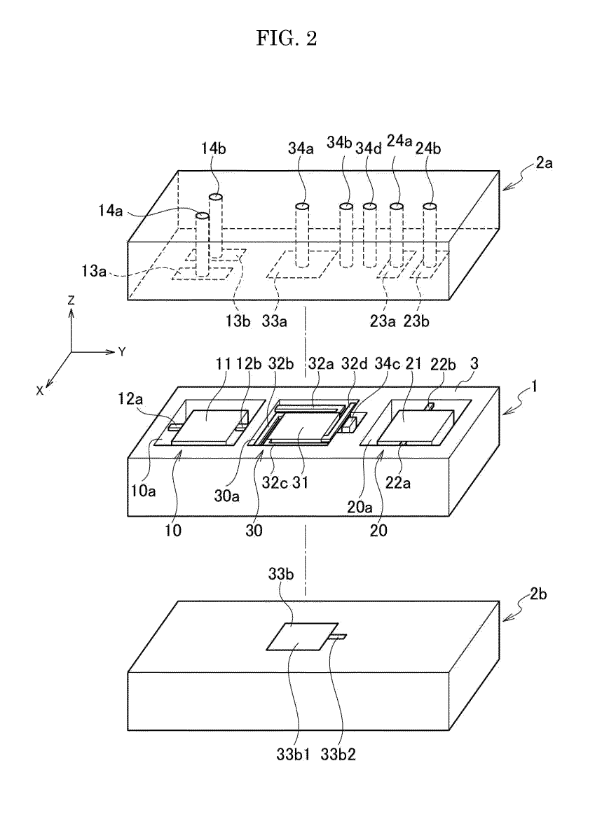

FIG. 2 is an exploded perspective view of the sensor (sensor chip 100) in accordance with this exemplary embodiment. As shown in this drawing, first substrate 1 is sandwiched between upper fixing plate 2a and second substrate 2b. First substrate 1 is formed of, for example, a silicon SOI substrate. Upper fixing plate 2a and second substrate 2b are formed of, for example, an insulator such as glass.

Hereinafter, in first substrate 1, a portion for detecting acceleration in a first direction (the Z direction in FIG. 2 in this exemplary embodiment) is referred to as “Z detection portion 30,” a portion for detecting acceleration in a second direction (the X direction in FIG. 2 in this exemplary embodiment) is referred to as “X detection portion 10,” and a portion for detecting acceleration in a third direction (the Y direction in FIG. 2 in this exemplary embodiment) is referred to as “Y detection portion 20”, respectively. The X direction is one direction in the planar direction. The Y direction is one direction in the planar direction, and is orthogonal to the X direction. The Z direction is the vertical direction.

Z detection portion 30 detects acceleration in the Z direction by parallel-moving first movable electrode 31 held by two pairs of beam portions 32a, 32b, 32c, 32d in the vertical direction. That is to say, third fixed electrodes 33a and 33b are disposed to face the front and back surfaces of first movable electrode 31, respectively. This makes it possible to detect acceleration in the Z direction based on a change of electrostatic capacitance between first movable electrode 31 and third fixed electrodes 33a and 33b. Note here that a configuration in which first movable electrode 31 is supported by the two pairs of beam portions 32a, 32b, 32c, and 32d is described, but a configuration is not limited to this. For example, a configuration in which one beam piece supports the first movable electrode may be employed. That is to say, a beam piece portion for supporting first movable electrode 31 is only required to support first movable electrode 31 such that first movable electrode 31 is displaced in response to the acceleration in the Z direction.

X detection portion 10 detects acceleration in the X direction by swinging second movable electrode 11 about a pair of beam portions 12a and 12b. That is to say, first fixed electrodes 13a and 13b are disposed to face one side and the other side of the front surface of second movable electrode 11 with a straight line linking the pair of beam portions 12a and 12b as a boundary. This enables detection of acceleration in the X direction based on a change in electrostatic capacitance between second movable electrode 11 and first fixed electrodes 13a and 13b. Note here that a configuration in which the pair of beam portions 12a and 12b support second movable electrode 11 is described, but the configuration is not limited to this. For example, a configuration in which one beam piece supports the movable electrode may be employed. That is to say, a beam piece portion for supporting second movable electrode 11 is only required to support second movable electrode 11 so that second movable electrode 11 is displaced in response to the acceleration in the Z direction.

Y detection portion 20 detects acceleration in the Y direction by swinging third movable electrode 21 about a pair of beam portions 22a and 22b. That is to say, second fixed electrodes 23a and 23b are disposed to face one side and the other side of the front surface of third movable electrode 21 with a straight line linking the pair of beam portions 22a and 22b as a boundary. This enables detection of acceleration in the Y direction based on a change in electrostatic capacitance between third movable electrode 21 and second fixed electrodes 23a and 23b. Note here that a configuration in which the pair of beam portions 22a and 22b support second movable electrode 11 is described, but the configuration is not limited to this. For example, a configuration in which one beam piece supports the movable electrode may be employed. That is to say, a beam piece portion for supporting third movable electrode 21 is only required to support third movable electrode 21 so that third movable electrode 21 is displaced in response to the acceleration in the Z direction.

By the way, X detection portion 10 and Y detection portion 20 are formed in the same shape, and they are only rotated by 90° with respect to each other. X detection portion 10 and Y detection portion 20 are arranged in one chip on both sides of Z detection portion 30 having a different shape. That is to say, as shown in FIG. 2, in frame portion 3, three rectangular frames 10a, 20a and 30a are aligned. Alternatively, in other words, second movable electrode 11 is provided in a position that faces third movable electrode 21 with first movable electrode 31 sandwiched therebetween.

By the way, second movable electrode 11 is disposed in rectangular frame 10a, third movable electrode 21 is disposed in rectangular frame 20a, and first movable electrode 31 is disposed in rectangular frame 30a, respectively. Each movable electrode has substantially a rectangular shape. There is a gap having a predetermined size between first movable electrode 31, second movable electrode 11, and third movable electrode 21 and sidewall portions of rectangular frames 30a, 20a, and 20a, respectively.

Note here that shapes of rectangular frames 10a, 20a, and 30a are not limited to a rectangle. For example, the shape may be circular, or various polygonal shapes.

Note here that shapes of first movable electrode 31, second movable electrode 11, and third movable electrode 21 are not limited to a rectangle. For example, the shape may be circular, or various polygonal shapes. In particular, it is preferable that the shape of first movable electrode 31 is a similar figure to the shape of rectangular frame 10a. As a result, an area of first movable electrode 31 (or a mass of first movable electrode 31) can be increased, so that the sensitivity of the sensor with respect to acceleration can be improved.

It is preferable that the shape of second movable electrode 11 is a similar figure to the shape of rectangular frame 10a. As a result, an area of second movable electrode 11 (or a mass of second movable electrode 11) can be increased, so that the sensitivity of the sensor with respect to acceleration can be improved.

It is preferable that the shape of third movable electrode 21 is a similar figure to the shape of rectangular frame 20a. As a result, an area of third movable electrode 21 (or a mass of third movable electrode 21) can be increased, so that the sensitivity of the sensor with respect to acceleration can be improved.

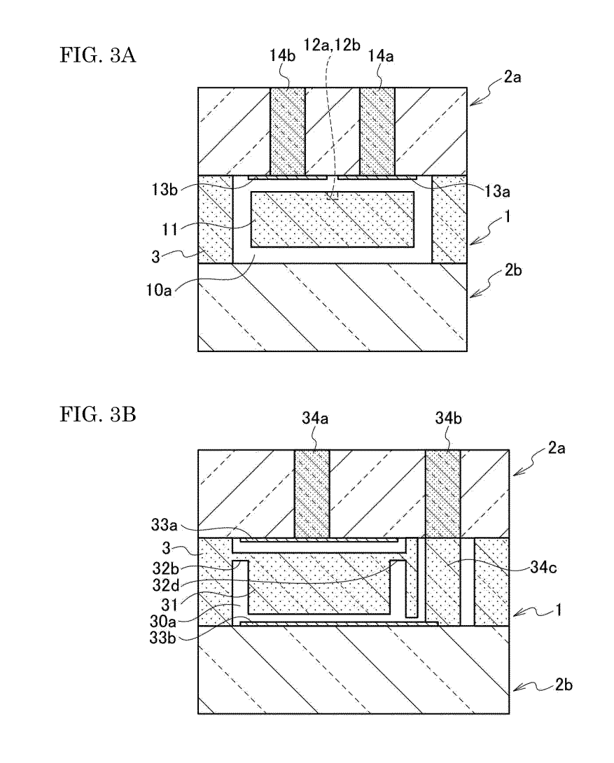

FIG. 3 is a sectional view of the sensor in accordance with this exemplary embodiment. (a) shows a section of X detection portion 10, and (b) shows a section of Z detection portion 30. Since a section of Y detection portion 20 is the same as that of X detection portion 10, it is not shown herein.

Firstly, in the section of X detection portion 10, substantially central portions of opposite two sides of the surface of second movable electrode 11 and the sidewall portions of rectangular frame 10a are linked to each other by a pair of beam portions 12a and 12b, so that second movable electrode 11 is swingably supported with respect to frame portion 3. First fixed electrodes 13a and 13b are provided around the straight line, which links beam portion 12a and beam portion 12b to each other, as a boundary, on upper fixing plate 2a on the side facing second movable electrode 11. First fixed electrodes 13a and 13b are pulled out to an upper surface (one side) of upper fixing plate 2a by using first through electrodes 14a and 14b. Material of first through electrodes 14a and 14b is a conductor such as silicon, tungsten, and copper, and material of a periphery thereof, which holds first through electrodes 14a and 14b, is an insulator such as glass.

In the section of Y detection portion 20, substantially central portions of opposite two sides of the surface of third movable electrode 21 and the sidewall portions of rectangular frame 20a are linked to each other by a pair of beam portions 22a and 22b, so that third movable electrode 21 is swingably supported with respect to frame portion 3. Second fixed electrode 23a and 23b are provided around the straight line, which links beam portions 22a and beam portion 22b to each other, as a boundary, on upper fixing plate 2a on the side facing third movable electrode 21. Second fixed electrodes 23a and 23b are pulled out to an upper surface of upper fixing plate 2a by using second through electrodes 24a and 24b. Material of second through electrodes 24a and 24b is a conductor such as silicon, tungsten, and copper, and material of a periphery thereof, which holds second through electrodes 24a and 24b, is an insulator such as glass.

Furthermore, in the section of Z detection portion 30, four corners of first movable electrode 31 and sidewall portions of rectangular frame 30a are linked to each other by two pairs of L-shaped beam portions 32a, 32b, 32c, and 32d, so that first movable electrode 31 can move in a parallel in the vertical direction. A shape of beam portions 32a, 32b, 32c, and 32d is not particularly limited, but when the shape is L-shape, the length of beam portions 32a, 32b, 32c, 32d can be increased. Third fixed electrode 33a is provided on upper fixing plate 2a at a side facing first movable electrode 31, and third fixed electrode 33b is provided on second substrate 2b at a side facing first movable electrode 31. Third fixed electrode 33a is pulled out to the upper surface of upper fixing plate 2a by using third through electrode 34a. Third fixed electrode 33b is provided with protruding region 33b2 protruding from rectangular region 33b1 (see, FIG. 2). Protruding region 33b2 is connected to columnar fixed electrode 34c separated from first movable electrode 31. Columnar fixed electrode 34c is connected to third through electrode 34b provided in upper fixing plate 2a. Thus, third fixed electrode 33b can be pulled out to the upper surface of upper fixing plate 2a by using columnar fixed electrode 34c and third through electrode 34b. Material of third through electrodes 34a and 34b is a conductor such as silicon, tungsten, and copper, and material of a periphery thereof, which holds third through electrodes 34a and 34b is an insulator such as glass.

Next, a principle of detecting acceleration in the X direction is described. Firstly, electrostatic capacitance C can be calculated from C=εS/d where ε is a dielectric constant, S is an opposing area of electrodes, and d is an opposing gap between the electrodes. When a movable electrode is rotated by acceleration, the opposing gap d is changed, and accordingly, the electrostatic capacitance C is changed. Then, differential capacitance (C1−C2) is subjected to C-V (capacitance-to-voltage) conversion by ASIC 200.

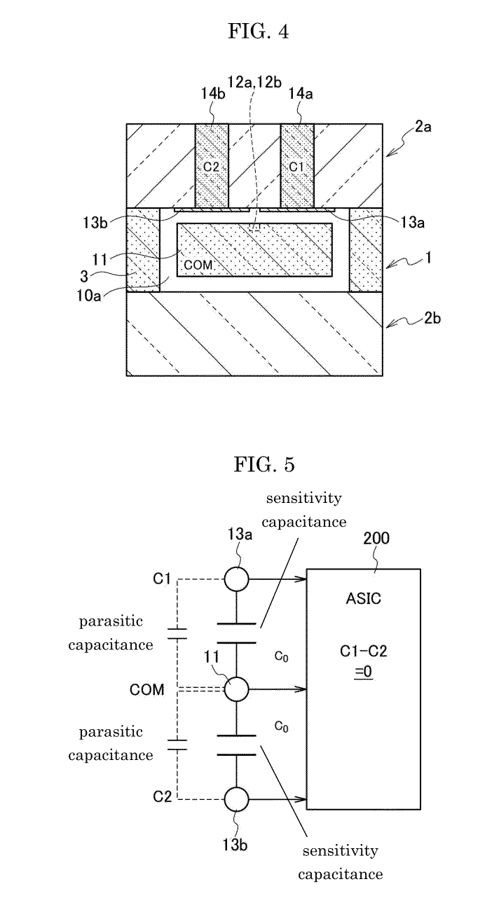

FIG. 4 shows a section of X detection portion 10 in a state in which acceleration in the X direction is not applied. In this case, as shown in FIG. 5, electrostatic capacitances C1 and C2 between second movable electrode 11 and first fixed electrodes 13a and 13b become equal to each other. ASIC 200 calculates a differential value (C1−C2=0) between the electrostatic capacitance C1 and the electrostatic capacitance C2, and outputs the calculated differential value as an X output.

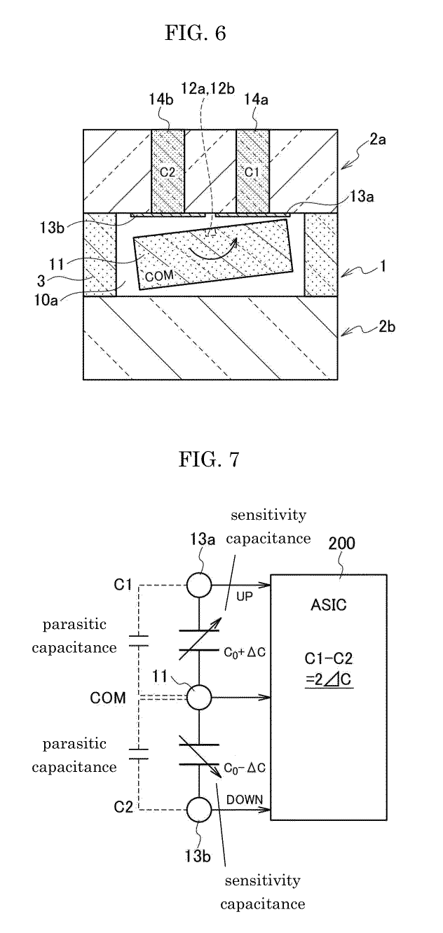

FIG. 6 shows a section of X detection portion 10 in a state in which acceleration of 1 G is applied in the X direction. In this case, as shown in FIG. 7, electrostatic capacitance C1 between second movable electrode 11 and first fixed electrode 13a becomes parasitic capacitance +ΔC, and electrostatic capacitance C2 between second movable electrode 11 and first fixed electrode 13b becomes parasitic capacitance −ΔC. ASIC 200 calculates a differential value (C1−C2=2ΔC) between electrostatic capacitance C1 and electrostatic capacitance C2, and outputs the calculated differential value as an X output.

As mentioned above, X detection portion 10 detects acceleration in the X direction based on the change of the electrostatic capacitances. The same is true to a principle on which Y detection portion 20 detects acceleration in the Y direction.

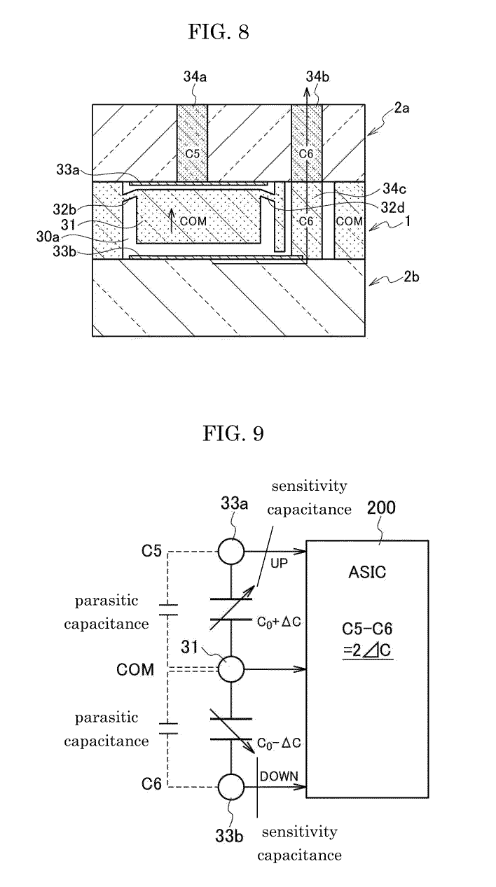

FIG. 8 shows a section of Z detection portion 30 in a state in which acceleration of 1 G is applied in the Z direction. In this case, as shown in FIG. 9, electrostatic capacitance C5 between first movable electrode 31 and third fixed electrode 33a becomes parasitic capacitance +ΔC, and electrostatic capacitance C6 between first movable electrode 31 and third fixed electrode 33a becomes parasitic capacitance −ΔC. ASIC 200 calculates a differential value (C5−C6=2ΔC) between electrostatic capacitance C5 and electrostatic capacitance C6, and outputs the calculated differential value as a Z output. Thus, Z detection portion 30 detects acceleration in the Z direction based on a change of electrostatic capacitance.

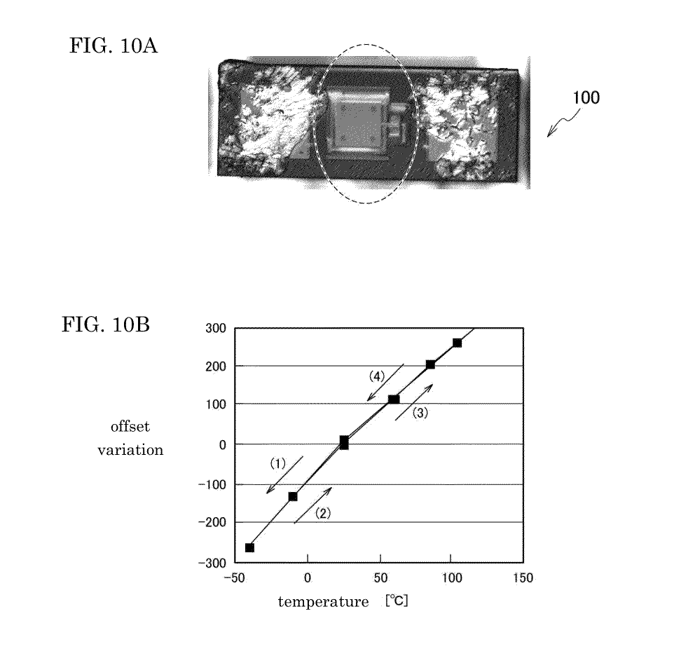

FIG. 10A is a photograph of an adhesive bonding surface of sensor chip 100 of the acceleration sensor in accordance with this exemplary embodiment. FIG. 10B is a graph showing offset temperature characteristics of the acceleration sensor in accordance with this exemplary embodiment. In this exemplary embodiment, a region corresponding to Z detection portion 30 in the adhesive bonding surface to third substrate 40 of the sensor, an attachment preventing region for preventing attachment of adhesive material such as die-bonding material is formed (mentioned later). Experiment of such a sensor shows that, as shown in FIG. 10B, occurrence of thermal hysteresis in the offset temperature characteristics can be suppressed. When deformation of third substrate 40 according to a temperature change is transferred to third fixed electrode 33b, an interval between first movable electrode 31 and third fixed electrode 33b is changed, causing an output of the inertial sensor to be changed. However, in the sensor in accordance with this exemplary embodiment, since second substrate 2b and third substrate 40 are not bonded to each other immediately below third fixed electrode 33b, deformation of third substrate 40 according to a temperature change is not easily transferred to third fixed electrode 33b. Accordingly, the occurrence of thermal hysteresis can be suppressed. However, third fixed electrode 33b is not an essential configuration. That is to say, even when third fixed electrode 33b is not provided, the occurrence of thermal hysteresis can be suppressed. This is because second substrate 2b and third substrate 40 are not bonded to each other immediately below first movable electrode 31, and thereby deformation of third substrate 40 according to a temperature change can suppress displacement of first movable electrode 31 via beam portions 32a to 32d. Accordingly, the occurrence of thermal hysteresis can be suppressed.

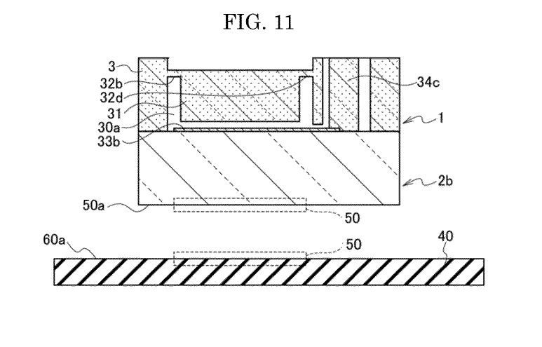

FIG. 11 is a sectional view of the sensor and third substrate 40 thereof in accordance with this exemplary embodiment. As shown in this drawing, the sensor of this exemplary embodiment has attachment preventing region 50, in which second substrate 2b and third substrate 40 are not bonded to each other, between first movable electrode 31 and third substrate 40.

An area of attachment preventing region 50 is not particularly limited, and attachment preventing region 50 in which second substrate 2b and third substrate 40 are not bonded to each other can be provided in at least a part between first movable electrode 31 and third substrate 40. Furthermore, in order to receive less effect of the die-bonding material, it is desirable that attachment preventing region 50 correspond to third fixed electrode 33a which is somewhat larger than first movable electrode 31.

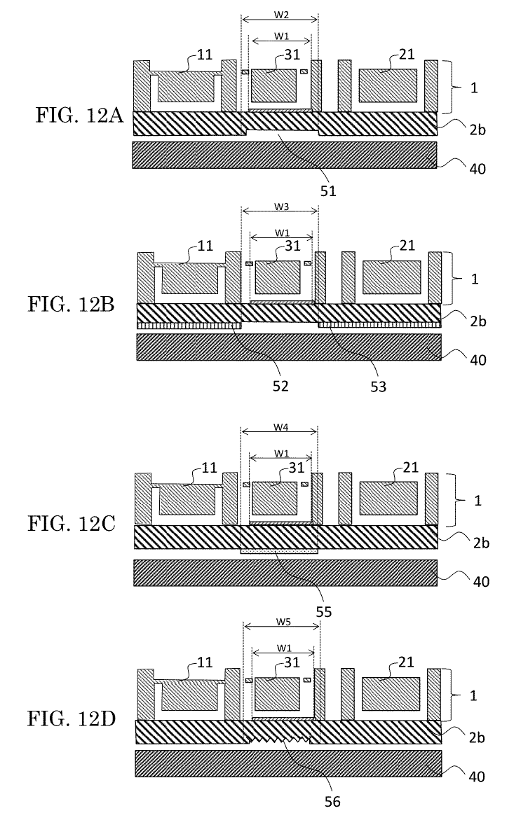

FIGS. 12A to 12D are sectional views each showing a specific example of an attachment preventing structure of the sensor in accordance with this exemplary embodiment. In FIGS. 12A to 12D, portions other than second substrate 2b in the sensor may not be shown.

When a sensor is mounted on third substrate 40, upper surface 60a of third substrate 40 is coated with die-bonding material, and the sensor is disposed thereon, followed hardening the die-bonding material by heating. In FIG. 12A, second substrate 2b has recess 51 between first movable electrode 31 and third substrate 40. With such a configuration, the lower part of Z detection portion 30 is recessed with respect to the lower parts of X detection portion 10 and Y detection portion 20. Consequently, the die-bonding material is attached to the lower parts of X detection portion 10 and Y detection portion 20, but the die-bonding material is not easily attached to the lower part of Z detection portion 30.

Alternatively, as shown in FIG. 12B, the lower part of X detection portion 10 and the lower part of Y detection portion 20 may be provided with first projections 52 having a predetermined height. For the first projection, for example, resin such as epoxy resin can be used. For example, an insulator such as glass can be used. When an insulator such as glass is used, the first projection may be provided unitarily with second substrate 2b, and may be provided separately. With such a configuration, the lower part of Z detection portion 30 is recessed with respect to the lower parts of X detection portion 10 and Y detection portion 20. Consequently, the die-bonding material is attached to the lower parts of X detection portion 10 and Y detection portion 20, but the die-bonding material is not easily attached to the lower part of Z detection portion 30.

Furthermore, second substrate 2b may have first projection 52 between second movable electrode 11 and third substrate 40, while second projection 53 between third movable electrode 21 and third substrate 40. Herein, first projection 52 and second projection 53 can be formed of a metal film. In this case, an adhesive bonding surface between third second substrate 2b and third substrate 40 is the surfaces of first projection 52 and second projection 53. As a result, the lower part of Z detection portion 30 is relatively recessed, so that recess 54 similar to the case of FIG. 12A can be formed.

Furthermore, as shown in FIG. 12C, water-repelling layer 55 may be provided between first movable electrode 31 and third substrate 40. Water-repelling layer 55 is only required to be capable of preventing second substrate 2b and third substrate 40 from being adhesively bonded to each other, and preventing attachment of the die-bonding material. That is to say, material for water-repelling layer 55 is not particularly limited. For example, hexamethyldisiloxane can be used. Also in this case, the die-bonding material is attached to the lower parts of X detection portion 10 and Y detection portion 20, but the die-bonding material is not easily attached to the lower part of Z detection portion 30.

Furthermore, as shown in FIG. 12D, region 56 having large surface roughness may be formed by roughening the surface between first movable electrode 31 and third substrate 40. The degree of surface roughness is not particularly limited, and only needs to be such a degree that it can prevent attachment of the die-bonding material. Also in this case, the die-bonding material is attached to the lower parts of X detection portion 10 and Y detection portion 20, but the die-bonding material is not easily attached to the lower part of Z detection portion 30.

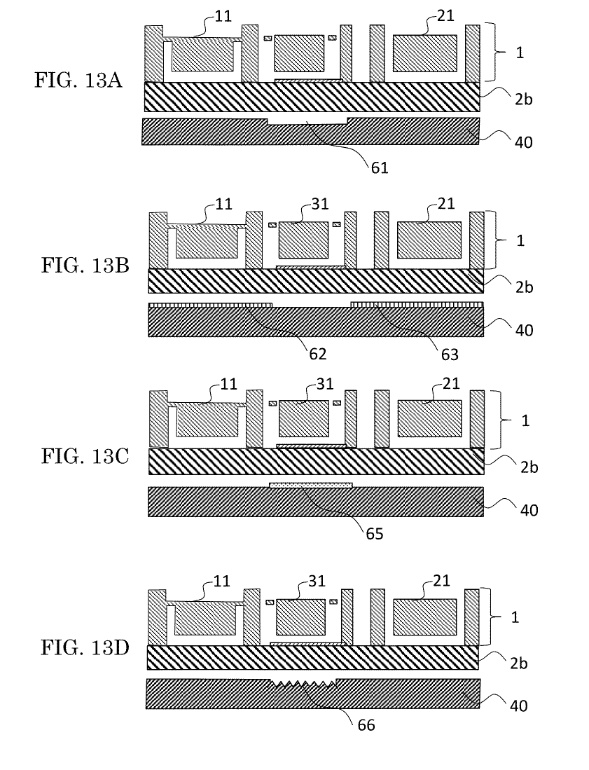

FIG. 13 is a sectional view showing a specific example of an attachment preventing structure of third substrate 40 of the sensor in accordance with this exemplary embodiment. Third substrate 40 is configured to allow a sensor to be mounted thereon, and includes, for example, package 300 as shown in FIG. 1. As described below, an attachment preventing structure similar to that of a sensor side can be provided also on a third substrate 40 side.

Firstly, as shown in FIG. 13A, recess 61 may be formed on third substrate 40 between first movable electrode 31 and third substrate 40. With such a configuration, the lower part of Z detection portion 30 is recessed with respect to the lower parts of X detection portion 10 and Y detection portion 20. Consequently, the die-bonding material is attached to the lower parts of X detection portion 10 and Y detection portion 20, but the die-bonding material is not easily attached to the lower part of Z detection portion 30.

Alternatively, as shown in FIG. 13B, third substrate 40 may have first projection 62 between second movable electrode 11 and third substrate 40, and second projection 63 between third movable electrode 21 and third substrate 40.

First projection 62 and second projection 63 can be formed of a metal film. In this case, an adhesive bonding surface to the sensor is surfaces of first projection 62 and second projection 63. As a result, the lower part of Z detection portion 30 is relatively recessed, so that recess 64 that is similar to the case of FIG. 13A can be formed.

Furthermore, as shown in FIG. 13C, coating of water-repelling layer 65 may be provided between first movable electrode 31 and third substrate 40. Material for water-repelling layer 65 is not particularly limited and only needs to be capable of preventing attachment of the die-bonding material. Also in this case, the die-bonding material is attached to the lower parts of X detection portion 10 and Y detection portion 20, but the die-bonding material is not easily attached to the lower part of Z detection portion 30.

Furthermore, as shown in FIG. 13D, region 66 having large surface roughness may be formed by roughening the lower part of Z detection portion 30. The degree of surface roughness is not particularly limited, and only needs to be such a degree that it can prevent the attachment of the die-bonding material. Also in this case, the die-bonding material is attached to the lower parts of X detection portion 10 and Y detection portion 20, but the die-bonding material is not easily attached to the lower part of Z detection portion 30.

Furthermore, configurations shown in FIGS. 12A to 12D or FIG. 13A to FIG. 13D are not limited to be used individually, and they can be employed in combination thereof. For example, water-repelling layer 55 shown in FIG. 12C and region 66 having large surface roughness shown in FIG. 13D may be used simultaneously.

Furthermore, it is preferable that width W2 of recess 51 shown in FIG. 12A (or, width W of recess 61 shown in FIG. 13A) is made larger than the width (W1) of third fixed electrode 33b. That is to say, it is a preferable configuration that second substrate 2b and third substrate 40 are not bonded to each other immediately below third fixed electrode 33b. This can effectively suppress an influence of the die-bonding material on third fixed electrode 33b.

Furthermore, it is preferable that interval W3 between first projection 52 and second projection 53 shown in FIG. 12B (or the interval between first projection 62 and second projection 63 shown in FIG. 13B) is made larger than the width (W2) of third fixed electrode 33b. That is to say, it is a preferable configuration that second substrate 2b and third substrate 40 are not bonded to each other immediately below third fixed electrode 33b. This can effectively suppress an influence of the die-bonding material on third fixed electrode 33b.

Furthermore, it is preferable that a width W4 of water-repelling layer 55 shown in FIG. 12C (or a width of water-repelling layer 65 shown in FIG. 13C) is made larger than the width (W1) of third fixed electrode 33b. That is to say, it is a preferable configuration that second substrate 2b and third substrate 40 are not bonded to each other immediately below third fixed electrode 33b. This can effectively suppress an influence of the die-bonding material on third fixed electrode 33b.

Furthermore, it is preferable that a width W5 of region 56 having large surface roughness shown in FIG. 12D (or region 66 having large surface roughness shown in FIG. 13D) is made wider than width (W1) of third fixed electrode 33b. That is to say, a configuration in which second substrate 2b and third substrate 40 are not bonded to each other immediately below third fixed electrode 33b is preferable. This can effectively suppress an influence of the die-bonding material on third fixed electrode 33b.

Note here that upper fixing plate 2a is not an essential configuration in the present invention. A case where upper fixing plate 2a is not provided includes, for example, a configuration capable of detecting a change of electrostatic capacitance between first substrate 1 and second substrate.

Furthermore, it is preferable that second substrate 2b incorporates a processing circuit for processing an electrical signal from first substrate 1. With this configuration, since first substrate 1 and a processing circuit can be laminated onto each other, thus enabling a size of an inertial sensor to be reduced.

Furthermore, third substrate 40 may be formed of laminated ceramic material using alumina material. Alternatively, it may be a part of a member constituting a ceramic package. According to this configuration, components other than a sensor, for example, other sensors such as a geomagnetic sensor, electrode terminals for being electrically connected to the outside can be provided on the third substrate. Alternatively, third substrate 40 may be a die pad formed of metal, or may a printed board.

In the above, preferable exemplary embodiments of the present invention are described. However, the present invention is not limited to the above-mentioned exemplary embodiments, and can be modified variously. For example, arbitrary two or more of the attachment preventing structures shown in FIGS. 12A to 12D and FIGS. 13A to 13D may be combined. Furthermore, these detailed specifications (shapes, sizes, layout and the like) of the attachment preventing structure can be also appropriately changed. Needless to say, the present invention can be achieved as a mounted structure of a sensor in which any one of the above-mentioned sensors is mounted on any one of the above-mentioned third substrates 40.

### REFERENCE MARKS IN THE DRAWINGS

1 first substrate
2b second substrate
10 X detection portion
10a, 20a, 30a rectangular frame
11 second movable electrode
12a, 12b, 22a, 22b, 32a, 32b, 32c, 32d beam portion
13a, 13b first fixed electrode
14a, 14b first through electrode
20 Y detection portion
21 third movable electrode
23a, 23b second fixed electrode
24a, 24b second through electrode
30 Z detection portion
31 first movable electrode
33a, 33b third fixed electrode
34a, 34b third through electrode
40 third substrate
50 attachment preventing region
51, 54, 61, 64 recess
52, 62 first projection
53, 63 second projection
55, 65 water-repelling layer
56, 66 region having large surface roughness
60 attachment preventing region

1. A sensor comprising:
a first substrate including a first movable electrode;
a second substrate connected to the first substrate and including a first fixed electrode that faces the first movable electrode; and
a third substrate connected to the second substrate,
wherein the first substrate, the second substrate, and the third substrate are laminated in this order, and the second substrate and the third substrate are not bonded to each other in at least a part between the first fixed electrode and the third substrate.

2. The sensor of claim 1, wherein the second substrate or the third substrate includes a recess between the first fixed electrode and the third substrate.

3. The sensor of claim 1, further comprising a water-repelling layer between the first fixed electrode and the third substrate.

4. The sensor of claim 1, wherein the first substrate further includes a second movable electrode and a third movable electrode,
surface roughness of the second substrate or the third substrate immediately below the first fixed electrode is larger than surface roughness of the second substrate or the third substrate immediately below the second movable electrode or the third movable electrode.

5. The sensor of claim 1, wherein the first substrate further comprises a second movable electrode and a third movable electrode,
a first connection portion for connecting the second substrate and the third substrate to each other is provided between the second movable electrode and the third substrate, and
a second connection portion for connecting the second substrate and the third substrate to each other is provided between the third movable electrode and the third substrate.

6. The sensor of claim 4, wherein
the first movable electrode is displaced in response to acceleration in a first direction,
the second movable electrode is displaced in response to acceleration in a second direction, and
the third movable electrode is displaced in response to acceleration in a third direction.

7. The sensor of claim 6, wherein the first direction, the second direction, and the third direction are orthogonal to one another.

8. The sensor of claim 7, wherein the second movable electrode is opposite to the third movable electrode with the first movable electrode sandwiched therebetween.

9. The sensor of claim 1, wherein the sensor detects acceleration by detecting a change of electrostatic capacitance.

10. The sensor of claim 5, wherein
the first movable electrode is displaced in response to acceleration in a first direction,
the second movable electrode is displaced in response to acceleration in a second direction, and
the third movable electrode is displaced in response to acceleration in a third direction.

11. The sensor of claim 10, wherein the first direction, the second direction, and the third direction are orthogonal to one another.

12. The sensor of claim 11, wherein the second movable electrode is opposite to the third movable electrode with the first movable electrode sandwiched therebetween.
